(19) United States
(12) Patent Application Publication
(10) Pub. No.: US 2011/0091702 A1
(43) Pub. Date: Apr. 21, 2011

(54) Composite Products and Methods for Manufacturing

(76) Inventor: Andrew Peter Pohl, Hampton, VA (US)

(21) Appl. No.: 12/603,112

(22) Filed: Oct. 21, 2009

(51) Int. Cl. B32B 7/02; B29C 43/18

(52) U.S. Cl. 428/218; 264/279.1; 156/245

(57) ABSTRACT

The present disclosure relates to a method for forming a composite product. The method involves compressing a semi-hydraulic medium within a compression cell thereby causing the semi-hydraulic medium to fill voids in the compression cell and to encapsulate an incompressible element within the compression cell. The present disclosure also relates to composite products made in accordance with the above method.

### TECHNICAL FIELD

The present disclosure relates generally to composite products and methods for making composite products.

### BACKGROUND

Historically, composite products having three-dimensional shapes have been difficult and expensive to manufacture. Example composite products may include three-dimensional products having multiple layers, each layer having different properties such as different chemical properties or different mechanical properties. Traditionally, such composite products have been manufactured using lamination-type processes in which different layers having different properties are bonded together. However, different layers having different mechanical properties (e.g., different strengths in compression or tension, different surface textures, different rigidities and different coefficients of thermal expansion) can lead to de-lamination. Furthermore, lamination processes generally involve multiple steps and can be quite time consuming. For example, bonding together different layers having different surface qualities and other mechanical properties typically requires the use of different types of adhesives with different bonding temperatures and curing times. Further, each step in the process generally requires relatively precise control and calibration to ensure a commercially acceptable end product results from the process. This adds to the time, expense and complexity of the processing.

Injection molding processes are also used to manufacture composite products. However, injection molding processes are typically limited in the types of materials that can be utilized. Additionally, injection molding processes often require substantial cleaning operations that take place typically between injections.

### SUMMARY

One aspect of the present disclosure relates generally to methods for efficiently making composite products, and to composite products made in accordance with such methods.

Another aspect of the present disclosure relates to a compression molding process in which compressible materials and incompressible materials are integrated into a composite product. In one embodiment, a single compression molding step is used to form the composite product.

Another aspect of the present disclosure relates to a compression molding process where first and second materials having different properties are integrated into a composite product in a single step compression operation. In one embodiment, the first material is compressible and flowable, and the second material is incompressible and non-flowable. In such embodiments, the first material can be compressed and concurrently caused to flow around and encapsulate the second material during the single step compression operation.

A further aspect of the present disclosure relates to composite products made through a compression molding process. In certain embodiments, the composite products include incompressible materials enclosed within an encapsulating material. In certain embodiments, the encapsulating material has a construction that allows it to compress in volume and flow relative to the incompressible material at the time the composite product is compression molded. In certain embodiments, the encapsulating material forms a unitary, monolithic and seamless shell, casing, matrix, or skin construction in which the incompressible material is embedded. In one particular embodiment, the encapsulating material includes a binder, a filler and a flow enhancing material.

### BRIEF DESCRIPTION OF THE DRAWINGS

FIG. 1 shows a compression molding system in accordance with the principles of the present disclosure, the compression molding system is shown in a pre-compression orientation;

FIG. 2 shows the compression molding system of FIG. 1 in a post-compression orientation;

FIG. 3 is a cross-sectional view taken along section line 3-3 of FIG. 2;

FIG. 4 shows the compression molding system of FIGS. 1 and 2 after the compression molding process has been completed and a finished composite product is ready to be removed from the compression mold of the compression molding system;

FIG. 5 shows a composite product made by the compression molding system of FIGS. 1-4;

FIG. 6 is a cross-sectional view taken along section line 6-6 of FIG. 5;

FIG. 7 is a cross-sectional view taken along section line 7-7 of FIG. 5;

FIG. 8 shows another compression molding system in accordance with the principles of the present disclosure, the compression molding system is shown in a pre-compression orientation;

FIG. 9 shows the compression molding system of FIG. 8 in a post-compression orientation;

FIG. 10 is a cross-sectional view taken along section line 10-10 of FIG. 9;

FIG. 11 shows the compression molding system of FIGS. 8-10 after the compression molding process has been completed and a finished composite product is ready to be removed from a compression mold of the compression molding system;

FIG. 12 shows a further compression molding system in accordance with the principles of the present disclosure, the compression molding system is shown in a pre-compression orientation;

FIG. 13 shows the compression molding system of FIG. 12 in a post-compression orientation;

FIG. 14 shows a composite product made with the compression molding system of FIGS. 12 and 13;

FIG. 15 is a cross-sectional view taken along section line 15-15 of FIG. 14; and

FIG. 16 is a cross-sectional view taken along section line 16-16 of FIG. 14.

### DETAILED DESCRIPTION

Certain aspects of the present disclosure relate to a compression molding system that allows for the manufacture of a multi-density composite product having a first material (e.g., a core, a reinforcing material, etc.) that is covered by a skin or matrix made of a second material in a single, shortened press-cycle. In certain embodiments, the skin encapsulates the first material and has a seamless, unitary and monolithic construction. In certain embodiments, the skin provides the composite product with a decorative outer surface. In certain embodiments, the skin is bonded to the first material and encapsulates the first material. In certain embodiments, the composite product is formed by a compression molding process in which materials having different properties are integrated together. In certain embodiments, the materials and degree of compression are selected to provide the composite product with desired properties (e.g., mechanical strength, water resistance, impact resistance, sound deadening, thermal insulating properties, fire proofing, bullet resistance, etc.).

Another aspect of the present disclosure relates to a process that uses a flowable medium with high bonding strength to bond and embed therein one or more elements thereby creating a composite product having a desired a three-dimensional shape. By embedding/encapsulating the elements within the flowable medium and then hardening the flowable medium with the elements embedded therein and bonded thereto, risk of de-lamination is reduced.

Further aspects of the present disclosure relate to a compression molding process where one or more non-compressible elements are incorporated into a composite product having a solid core. One example product of this type can include a panel structure such as a door having one or more internal layers of non-compressible material encapsulated within a seamless, monolithic matrix that surrounds and is bonded to the non-compressible element or elements. Another aspect of the present disclosure relates to a composite product having a generally hollow core surrounded by a composite wall structure having a non-compressible element or elements encapsulated within a seamless, monolithic matrix of encapsulant. Examples of this type of product include a bucket, a casket or portion of a casket, or any other structure including a reinforced composite wall structure defining an inner cavity.

A further aspect of the present disclosure relates to a method for manufacturing a composite product made within a compression cell formed by a female cell component and a male cell component. A press can be used to force the male cell component and the female cell component together. In use, a semi-hydraulic medium can be loaded into the female cell component. By “semi-hydraulic”, it is meant that the medium includes at least some hydraulic characteristics such as flowability and the ability to transfer at least some pressure. One or more incompressible elements (e.g., members, components, structures, sheets, panels, etc.) are also positioned within the compression cell. Examples of incompressible elements include wood products such as wood paneling, plywood or press-board. Other examples of incompressible elements include sheetrock, plaster, aramid yarn reinforced paneling, fiberglass reinforced paneling and other structures. By “incompressible” elements or members, it is meant that the elements or members are relatively less compressible than the semi-hydraulic medium. When the male and female cell components are forced together by the press, the semi-hydraulic medium is compressed in volume and flows to fill voids within the compression cell. Concurrently, the semi-hydraulic medium flows around and encapsulates the incompressible elements.

In certain embodiments, the compression cell can include heating structures (e.g., heating coils) for heating the material within the compression cell as the components of the compression cell are forced together. In this way, the semi-hydraulic medium is melted at the same time it is compressed so that the semi-hydraulic medium flows around and encases the incompressible elements and conforms to the shape of the female cell component.

In certain embodiments, the semi-hydraulic medium is compressed in volume at a ratio of at least 3 to 1 (i.e., a volume reduction of at least 66.7%) during the compression step within the compression cell. In other embodiments, the semi-hydraulic medium is compressed in volume at a ratio of at least 4 to 1 (i.e., a volume reduction of at least 75%), or at least 5 to 1 (i.e., a volume reduction of at least 80%), or at least 6 to 1 (i.e., a volume reduction of at least 83.8%) during the compression step within the compression cell. In contrast, the incompressible elements experience substantially no changes in volume or insignificant changes in volume during the compression step.

It is preferred for the semi-hydraulic medium to constitute an aggregate formed by a mixture of different materials. The mixture can include a bonding agent that causes the semi-hydraulic medium to bond to the incompressible elements. In one embodiment, the mixture includes a filler, a flow enhancer and a flowable binder. Example fillers include sand, saw dust, ground paper, etc. Flow enhancers are preferably capable of melting and flowing upon application of heat and pressure. Example flow enhancers can have a powder, particulate or granular form that changes volume and/or flow characteristics under pressure. Example flow enhancers can include a rubber material such as granular/particulate rubber. An example rubber material includes processed (e.g., ground, chopped, pulverized) tire material. Example binders include thermo-plastics and duro-plastics such as epoxies, urethanes, polyesters, etc. A preferred binder includes methylene diphenyl diisocyanate.

The incompressible elements are generally not flowable and are generally configured so that the incompressible elements do not have meaningful reduction in volume during the compression molding process. By using incompressible elements in combination with a compressible medium, the overall compressibility of the material within the compression cell is reduced as compared to if no incompressible elements were used. In one embodiment, the combination of compressible medium with the incompressible elements has an overall volume compression ratio less than 4 to 1 (i.e., a 75% reduction in volume) and greater than 2 to 1 (i.e., a 50% reduction in volume) during the compression step within the compression cell. The incompressible elements can also be referred to as solid elements (e.g., solid panels, solid members, solid reinforcements). As used herein, a “solid element” means an element that does not flow perceptibly even under moderate stress. The incompressible elements are preferably self-supporting elements. “Self supporting” elements are elements that maintain a three-dimensional shape without support and do not flow to an angle of repose.

In still other embodiments of the present disclosure, a flowable and compressible medium is first loaded into a female cell component. Subsequently, an incompressible element is forced into the flowable and compressible medium with a male cell component that is pressed toward the female cell component (i.e., the incompressible element is plunged or driven into the compressible and flowable medium). As the incompressible element is forced into the compressible and flowable medium, the compressible and flowable medium is compressed in volume and is caused to flow around the incompressible element causing the incompressible element to be encapsulated within the flowable and compressible medium.

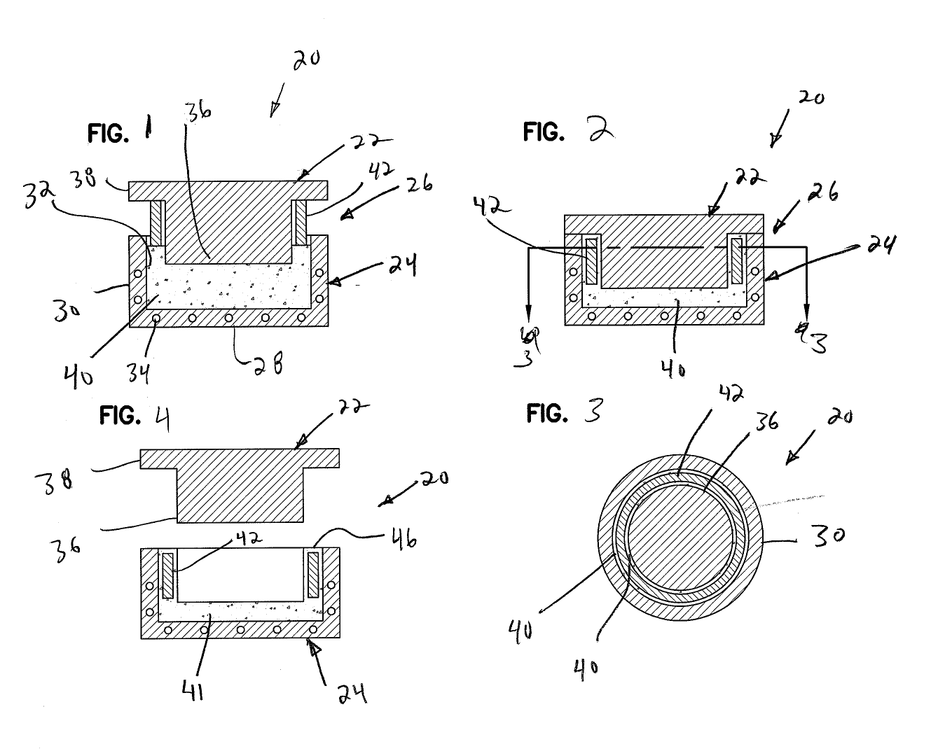

FIGS. 1-4 show a compression molding apparatus 20 in accordance with the principles of the present disclosure. The compression molding apparatus 20 includes first and second mold components 22, 24 that cooperate to define a compression cell 26. In use, material desired to be molded is positioned between the mold components 22, 24 and the mold components 22, 24 are then forced together (e.g., with a high pressure press such as a high pressure platen press) to compress the material so that the material forms a composite product having a three-dimensional outer shape that is the negative shape of the interior shape of the compression cell 26.

As depicted in FIGS. 1-4, the second mold component 24 is depicted as female mold component. The second mold component 24 includes a bottom wall 28 and a side wall structure 30 that projects upwardly from the bottom wall 28. The bottom wall 28 and the side wall structure 30 cooperate to define a cavity 32. As shown at FIG. 3, the side wall structure 30 is generally circular and surrounds the cavity 32 on all sides. The second mold component 24 can include heating elements 34 (e.g., heating coils or other heating structures) for heating the material within the compression cell 26 during a compression cycle.

As depicted in FIGS. 1-4, the first mold component 22 is a male mold component. The first mold component 22 includes a plug portion 36 that projects downwardly from a lid or cover portion 38.

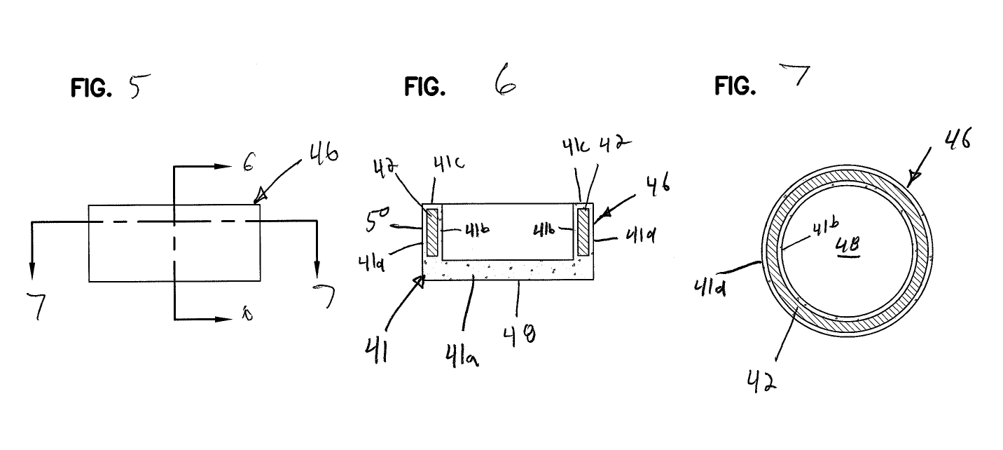

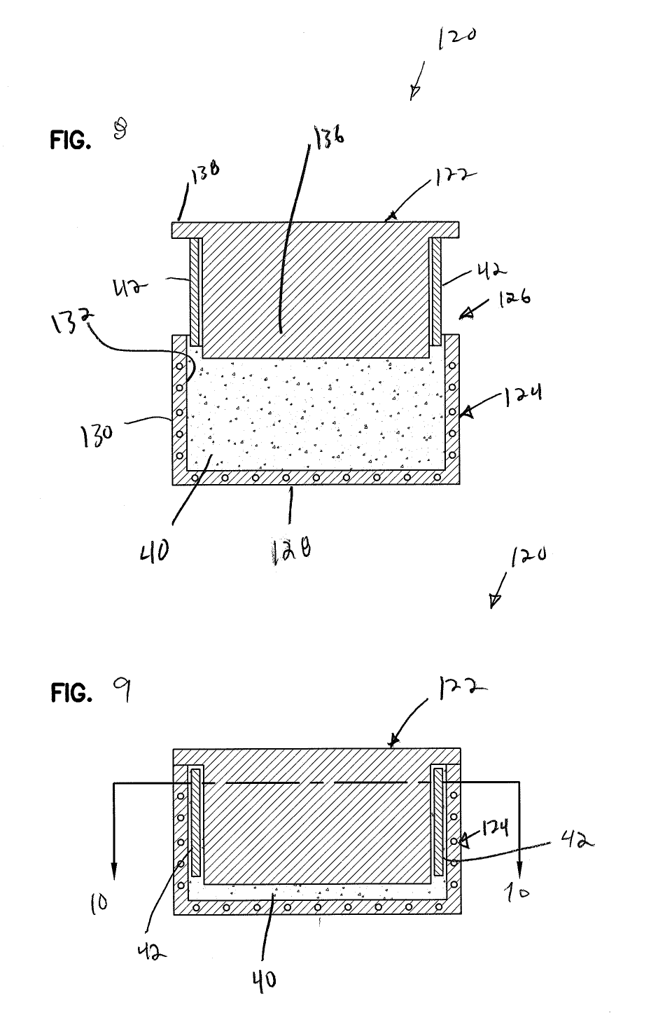

In accordance with the principles of the present disclosure, the compression molding apparatus 20 is used to manufacture a composite product in a single compression step. The compression molding apparatus is particularly suited for forming composite products having open tops and hollow interior regions surrounded by a reinforced wall structure. FIGS. 5-7 show a bucket/pail 46 that is an example of the type of composite structure that can be made with the compression molding apparatus 20.

To manufacture composite product using the compression molding apparatus 20, at least two different types of materials having different mechanical and/or chemical properties are preferably used. For example, as shown at FIGS. 1 and 2, a semi-hydraulic medium 40 and a non-flowable, incompressible material 42 are used in concert with the compression molding apparatus 20 to form a composite product. It will be appreciated that the ability of the semi-hydraulic medium 40 to transfer pressure increases as the material 40 is compressed in volume.

In use of the compression molding apparatus 20, the semi-hydraulic medium 40 (e.g., a mixture of filler, binder and a flow enhancer) is loaded into the cavity 32 of the second mold component 24 and the incompressible material 42 (e.g., a curved sheet or panel such as a curved wood sheet or sheets) is positioned around the plug portion 36 of the first mold component 22. Next, the semi-hydraulic medium 40 within the second mold component 24 is heated and the first and second mold components 22, 24 are forced together to close the compression cell 26. As the first and second mold components 22, 24 are forced together, the plug portion 36 compresses the semi-hydraulic medium 40 within the cavity 32 causing the semi-hydraulic medium 40 to flow upwardly into the region between the plug portion 36 and the side wall structure 30. Concurrently, the incompressible material 42 is forced downwardly by the first mold component 22 into the semi-hydraulic medium 40 in the region between the plug portion 36 and the side wall structure 30. As the incompressible material 42 is forced downwardly, the incompressible material 42 assists the plug portion 36 in compressing the semi-hydraulic medium 40. The compressed semi-hydraulic medium 40 flows upwardly around the incompressible material 42 such that the semi-hydraulic medium 40 encapsulates the incompressible material 42 as shown at FIG. 2 (e.g., the semi-hydraulic medium 40 fills the space between the incompressible material 42 and the side wall structure 30 and also fills the space between the incompressible material 42 and the plug portion 36). Concurrently, the plug portion 36 forms a hollow void within the composite product being manufactured. Thus, an outer portion of the semi-hydraulic medium 40 is molded to assume a shape that is the negative of the shape defined by the cavity 32 and an inner portion of the semi-hydraulic medium 40 is molded to assume a shape that is the negative of the plug portion 36.

After the heating and compression step, the semi-hydraulic medium 40 cures or otherwise hardens to form a set shape. Thereafter, the first mold component 22 can be separated from the second mold component 24 (as shown at FIG. 4) and the final molded composite product (e.g., bucket 46) can be removed from the second mold component 24.

As shown at FIGS. 5-7, the bucket 46 has a composite construction and includes a bottom 48, a side wall structure 50 that projects upwardly from the bottom 48, and a hollow core or interior 52. The side wall structure 50 has a reinforced composite construction. For example, the side wall structure 50 is formed by the combination of the incompressible material 42 which is encapsulated within a matrix 41 formed by the hardened/cured semi-hydraulic medium 40. The matrix 41 completely surrounds and is bonded to the incompressible material 42 so as to cooperate with the incompressible material 42 to form the side wall structure 50. The matrix 41 also forms the bottom of the bucket 46. As shown at FIG. 6, the matrix 41 has a monolithic, unitary or seamless construction. For example, the matrix 41 includes a bottom portion 41a forming the bottom of the bucket 46, an inner portion 41b lining the inside of the incompressible material 42, a top portion 41c lining the top of the incompressible material 42 and an outer portion 41d lining the outside of the incompressible material 42. All of the portions 41a-41d are monolithic/unitary with respect to one another such that no seams are provided between any of the portions 41a-41d. The monolithic construction of the portions 41a-41d is the result of the single step molding operation provided by the compression molding apparatus 20. The reinforced side wall structure 50 of the bucket 48 provides impact resistance and also provides reinforcement for better supporting a handle that may be attached to the side wall structure 50.

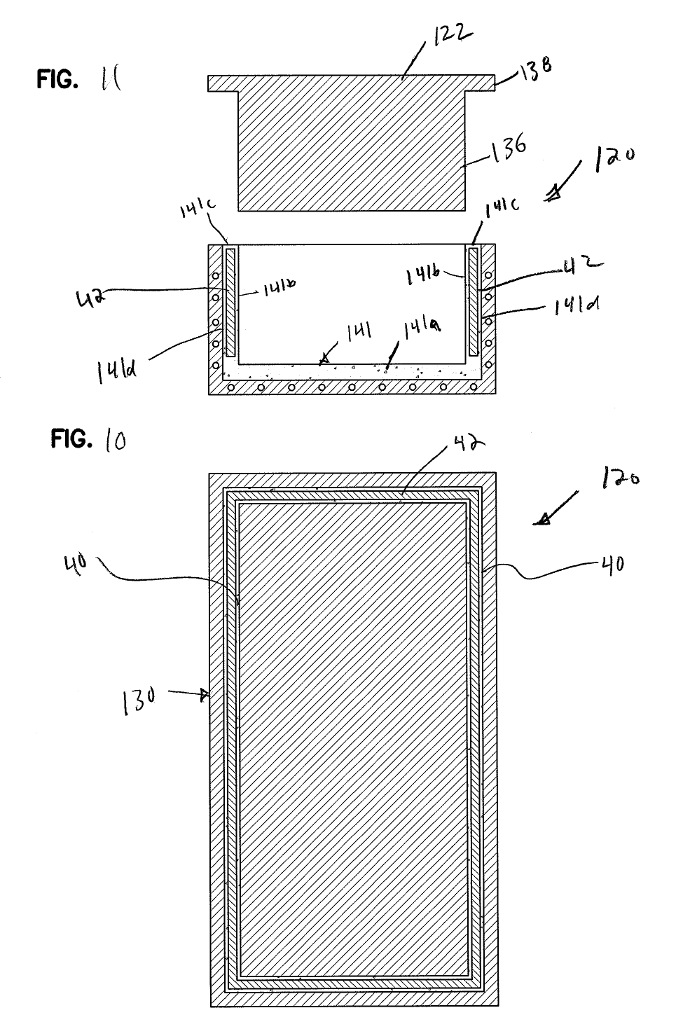

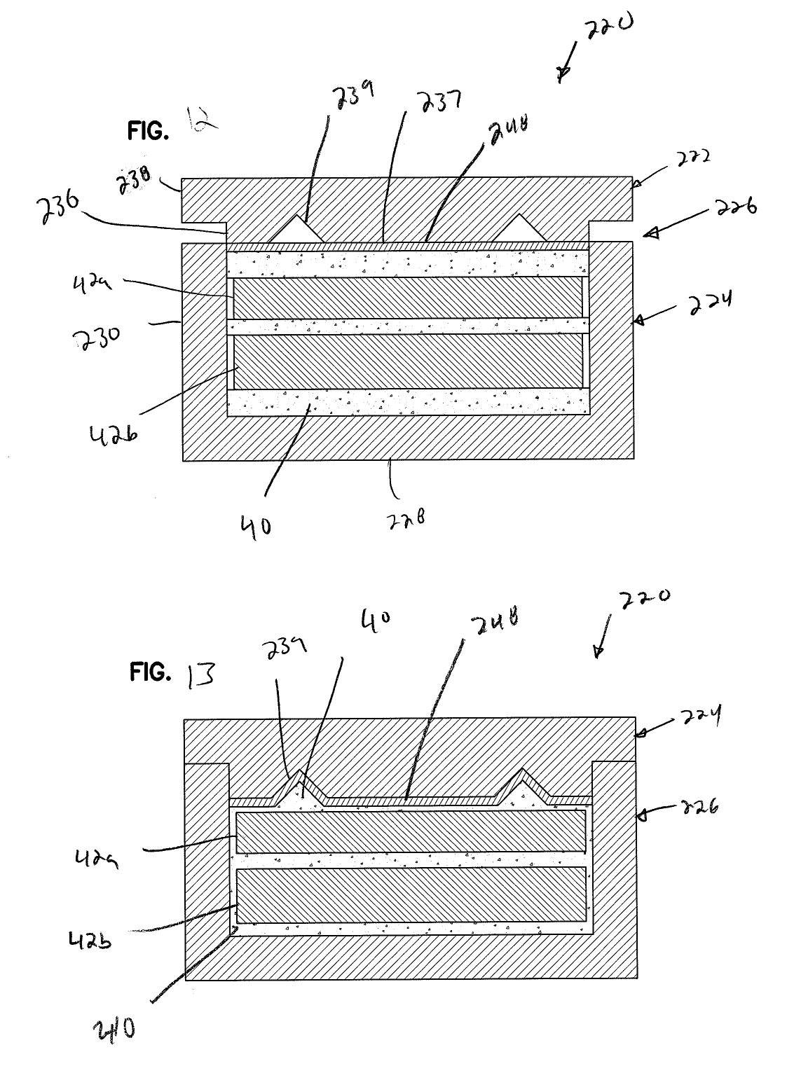

FIGS. 8-11 show another compression molding apparatus 120 in accordance with the principles of the present disclosure. The compression molding apparatus 120 is adapted for use in forming a generally rectangular composite structure having a hollow interior. An example composite structure having this type of structure can include a casket structure 146 (see FIG. 11).

Referring to FIGS. 8-11, the compression molding apparatus 120 includes a first mold component 122 and a second mold component 124 that cooperate to define a compression cell 126. The second mold component 124 includes a bottom wall 128 and a side wall structure 130. The side wall structure 130 has as generally rectangular configuration and includes a front side wall 130a, a right side wall 130b, a back side wall 130c and a left side wall 130d. Heating elements 134 are provided within the side wall structure 130. The first mold component 122 includes a plug portion 136 having a rectangular configuration and a cover portion 138 having a rectangular configuration.

The compression molding apparatus 120 is used in the same manner as the compression molding apparatus 20 described above. For example, the semi-hydraulic medium 40 (e.g., a mixture including components such as a binder, a filler and a flow enhancer) can be positioned within the cavity 132 of the second mold component 124 and the incompressible material 42 (e.g., one or more sheets or panels such as wood sheets) can be positioned around the plug portion 136 of the first mold component 122. The incompressible material 42 can be provided in a rectangular shape that is slightly larger than the rectangular shape of the plug portion 136. To mold the composite product, the semi-hydraulic medium 40 is heated within the second mold component 24 and the first and second mold components 22, 24 are pressed together to drive the plug portion 136 and the incompressible material 42 into the semi-hydraulic medium 40 within the cavity 132 thereby causing the semi-hydraulic medium 40 to be compressed in volume and to flow upwardly around the incompressible material 42 (e.g., into voids located between the incompressible material 42 and the side wall structure 130 and also into voids between the incompressible material 42 and the plug portion 136). As the semi-hydraulic medium 40 is compressed, the material 40 flows into voids within the compression cell 126. Additionally, an outer portion of the semi-hydraulic medium 40 is molded to assume the shape defined by the cavity 132 and an inner portion of the semi-hydraulic medium 40 is molded to assume a shape that is the negative of the plug portion 136.

After the compression process is over and the material 40 has cured or otherwise hardened, the composite product (e.g., the casket structure 146) can be removed from the cavity 132. The resulting casket structure 146 has an integrated construction in which the incompressible material 42 is encased within a matrix 141 formed by the hardened semi-hydraulic material 40. Similar to the matrix 41 forming the bucket 46, the matrix 141 has a monolithic, seamless construction. For example, the matrix 141 includes a bottom portion 141a forming the bottom of the casket structure 146, an inner portion 141b lining the inside of the incompressible material 42, a top portion 141c lining the top of the incompressible material 42 and an outer portion 141d lining the outside of the incompressible material 42. All of the portions 141a-141d are monolithic/unitary with respect to one another such that no seams are provided between any of the portions 141a-141d.

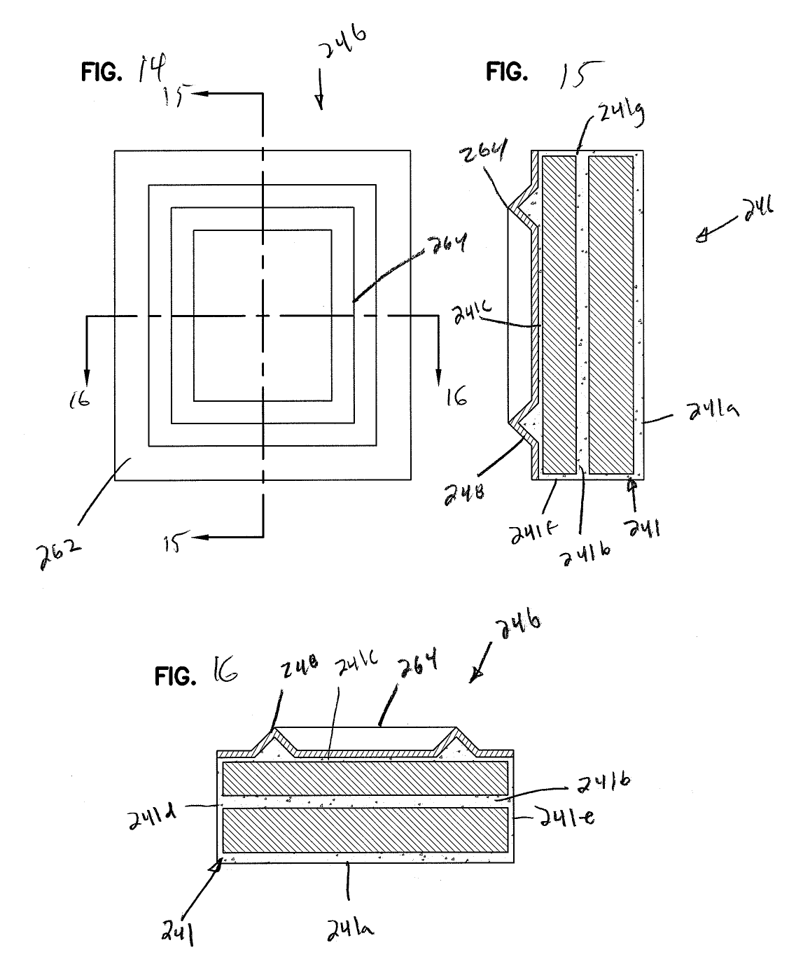

FIGS. 12 and 13 show a further compression molding apparatus 220 in accordance with the principles of the present disclosure. The compression molding apparatus 220 is configured for forming a composite three-dimensional panel structure such as a door 246 (see FIGS. 14-16). Generally, the compression molding apparatus 220 includes a first mold component 222 and a second mold component 224 that cooperate to define a compression cell 226. The second mold component 224 includes a bottom wall 228 and a generally rectangular side wall structure 230 that projects upwardly from the bottom wall 228. The bottom wall 228 and the side wall structure 230 cooperate to define a rectangular cavity 232. Similar to the previously described embodiments, heating elements can be provided in the second mold component 224.

Referring still to FIGS. 12 and 13, the first mold component 222 includes a projection portion 236 that projects downwardly from a cover portion 238. The projection portion 236 is configured to fit inside the cavity 232 of the second mold component 224. The extension portion 236 can include a bottom side 237 that is contoured/shaped so as to provide a decorative three-dimensional pattern on a face of the composite product (e.g., the door 246) made within the compression molding apparatus 220. For example, the bottom side 237 of the extension portion 236 can include a recess 239 having a triangular cross-sectional shape. The recess 239 extends in a rectangular pattern along the bottom side 237. The recess 239 is suitable for forming a ridge (e.g., a ridge 264 at a front side 262 of the door 246 of FIGS. 14-16) in the reverse image of the recess 239 on the upwardly facing face of the door 246.

In use of the compression molding apparatus 220, multiple materials can be loaded into the cavity 232. For example, layers of the semi-hydraulic medium 40 (e.g., top, bottom and intermediate layers) can be positioned within the cavity 232. The layers of the semi-hydraulic medium 40 can be separated from one another by layers formed by the incompressible material 42. For example, one incompressible layer 42a can be formed by a wood material such as plywood, pressboard, wood paneling or other material to provide reinforcement to the door 246. Another incompressible material 42b can be provided in another layer within the compression cell 26. The second layer of incompressible material 42b can be adapted to provide the door 246 with other mechanical or chemical properties. For example, the layer 42b can be formed of a fire retardant material such as plaster, an impenetrable material such as Kevlar shielding, a noise deadening material such as glass, foam, or a combination thereof, or other materials having desirable other properties. While two of the layers of incompressible material are shown in FIGS. 12 and 13, it will be appreciated that in alternative embodiments, products can be made with one such incompressible layer or more than two such incompressible layers. FIGS. 12 and 13 also show a decorative film 248 positioned over the top layer of the semi-hydraulic medium 40.

In use of the compression molding apparatus 220, the materials within the compression cell 226 are heated and the first and second mold components 222, 224 are pressed together to cause compression of the layers of semi-hydraulic medium. As the layers of semi-hydraulic medium 40 are heated and compressed, the layers of semi-hydraulic medium 40 flow to fill voids within the compression cell 226. For example, the medium 40 flows to fill voids located between the incompressible layers 42a, 42b and the side wall structure 230. Thus, the layers of semi-hydraulic medium 40 flow to fully encapsulate the incompressible layers 42a, 42b. As so compressed, the outer surface defined by the semi-hydraulic medium 40 conforms to the inner shape of the second mold component 224. Additionally, the decorative film 248 conforms to the decorative shape provided on the bottom side 237 of the extension portion 236 of the first mold component 222. For example, the film 248 conforms to the shape of the recess 239. Furthermore, the semi-hydraulic medium 40 also flows into the recess 239 beneath the film 248 to fill the void and fully support the decorative film 248. Upon curing or otherwise hardening, the semi-hydraulic medium 40 bonds to the decorative film 248 and also bonds to the incompressible layers 42a, 42b to form a relatively rigid, integrated door structure.

FIGS. 14-16 show the rigid, integrated door structure 246 made with the compression molding apparatus 220 of FIGS. 12 and 13. The door structure 246 includes front side 262 with rectangular decorative ridge 264 having a triangular cross-sectional shape that matches the shape of the recess 239 provided at the bottom side 237 of the extension portion 236. The film 248 forms a decorative layer located at the front side 262 of the door 246. As shown at FIGS. 15 and 16, the incompressible layers 42a, 42b are fully enclosed and encapsulated within a matrix 241 formed by the hardened semi-hydraulic material 40. Each of the layers 42a, 42b is individually encapsulated by the matrix 241 since an intermediate portion 241b of the matrix 241 is positioned between the layers 42a, 42b and bonded to the layers 42a, 42b. The matrix 241 includes a bottom portion 241a, the intermediate portion 241b, a top portion 241c, side portions 241d and 241e, and end portions 241f and 241g that are all joined together by seamless connections so as to form a unitary/monolithic structure that encases and bonds together the layers 42a, 42b. The matrix 241 can be referred to as a shell, liner, encasement, layer, skin or like terms.

What is claimed is:

1. An apparatus to produce multi-density and multi-structure products and cover them with a decorative skin in a single compression step.

2. The apparatus of claim 1, wherein a semi-hydraulic medium is compressed to a fraction of its original volume and forced to flow around and bond to other solids in a compression chamber.

3. The apparatus of claim 2, wherein at least one solid component outside the compression chamber is used to create pressure inside the compression chamber.

4. Products with multiple densities and chemical, mechanical properties bonded together and embedded in a pressure-chamber where the original volume is also reduced to at least half the original volume.

5. A method for forming a composite product, the method comprising:
compressing a semi-hydraulic medium within a compression cell thereby causing the semi-hydraulic medium to fill voids in the compression cell and to encapsulate an incompressible element within the compression cell.

6. The method of claim 5, wherein the compression cell includes a first mold component defining a mold cavity in which the semi-hydraulic medium is located, and wherein the semi-hydraulic medium is compressed by forcing a solid structure into the mold cavity.

7. The method of claim 6, wherein the solid structure includes a portion of a second mold component.

8. The method of claim 7, wherein the solid structure also includes the incompressible element.

9. The method of claim 5, wherein the semi-hydraulic medium includes a mixture of a binder, a filler and a flow enhancer.

10. The method of claim 9, wherein the binder includes methylene diphenyl diisocyanate and the flow enhancer includes processed tires.

11. The method of claim 5, wherein the incompressible element is selected from a group consisting a wood sheet, plywood, press board, aramid sheeting, fiber reinforced sheeting or plaster.

12. The method of claim 5, wherein the semi-hydraulic medium includes a flow enhancer having a form selected from the group consisting of granules, particles and powder.

13. The method of claim 12, wherein the semi-hydraulic medium includes a binder selected from the group consisting of duro-plastics and thermo-plastics.

14. The method of claim 13, wherein the binder includes methylene diphenyl diisocyanate.

15. The method of claim 13, wherein the flow enhancer includes granular rubber.

16. A method for making a hollow composite product having an open top using a compression mold, the compression mold including a first mold component including a plug portion and a cover portion, the compression mold also including a second mold component having a bottom wall and a side wall structure defining a mold cavity, the method comprising:
loading a semi-hydraulic medium into the mold cavity;
forcing the plug portion of the first mold component and an incompressible structure into the mold cavity to compress the semi-hydraulic medium in volume, wherein the incompressible structure is forced into a region between the plug portion and the side wall structure of the second mold component, wherein the compressed semi-hydraulic medium flows around the incompressible structure to encapsulate the incompressible structure, and wherein the semi-hydraulic medium conforms to a shape of the mold cavity; and
hardening the semi-hydraulic medium to form a matrix that encapsulates and is bonded to the incompressible structure, wherein the plug portion of the first mold component forms a hollow region within the matrix and the matrix and the incompressible element cooperate to define a reinforced wall structure that extends around the hollow region.

17. A method for making a door using a compression mold, the compression mold including a first mold component and a second mold component, the second mold component having a bottom wall and a side wall structure defining a mold cavity, the method comprising:
providing a bottom layer of semi-hydraulic medium in the mold cavity;
providing a first incompressible structure in the mold cavity above the bottom layer of semi-hydraulic medium, the first incompressible structure being panel-shaped;
providing a top layer of semi-hydraulic medium in the mold cavity above the first incompressible structure;
forcing the first mold component into the mold cavity to compress the semi-hydraulic medium in volume, wherein the compressed semi-hydraulic medium flows around the first incompressible structure to encapsulate the incompressible structure, and wherein the semi-hydraulic medium conforms to a shape of the mold cavity; and
hardening the semi-hydraulic medium to form a matrix that encapsulates and is bonded to the first incompressible structure.

18. The method of claim 17, further comprising loading a decorative film over the top layer of semi-hydraulic medium, wherein the decorative film covers a front side of the door and is bonds to the matrix.

19. The method of claim 17, further comprising providing a second incompressible structure in the mold cavity between the first incompressible structure and the top layer of semi-hydraulic medium, providing an intermediate layer of semi-hydraulic medium between the first and second incompressible structures, and wherein when the semi-hydraulic medium is compressed the semi-hydraulic medium flows around and encapsulates the first and second incompressible structures.
